(19) United States
(12) Patent Application Publication
(10) Pub. No.: US 2006/0019219 A1
(43) Pub. Date: Jan. 26, 2006

(54) Method to determine position and orientation of the axis of a dental implant disposed directly in the mouth of the patient as well as a mounting piece

(76) Inventors: Gunter Saliger, Bensheim (DE); Ulrich Orth, Lautertal (DE); Steffen Teckentrup, Heppenheim (DE); Reinhard Pieper, Bensheim (DE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/184,892

(22) Filed: Jul. 20, 2005

(30) Foreign Application Priority Data
Jul. 20, 2004 (DE) 10 2004 035 091.4

(51) Int. Cl. A61C 8/00; A61C 19/04

(52) U.S. Cl. 433/173; 433/72

(57) ABSTRACT

A method for determining the position and orientation of the axis of a dental implant disposed directly in the mouth of a patient wherein measurement data is obtained by measurement of the clinical situation of the implant in the patient's mouth, a first shape to be measured is applied to the implant, the shape is formed in such a manner that a conclusion can be made about the position and orientation of a connection shape of the implant, and the position and orientation of the first shape is analyzed through a suitable method. Furthermore, the relative position and orientation of the area between the axis of the dental implant and the axis of the measurement is defined through the specific position of the first shape. The position and orientation of the connection shape and of the implant itself is determined through the first shape. A mounting piece for an implant inserted in a jaw or a manipulation implant in a working model can be used thereby having a coded section and an extension whose length is coded in the section.

### BACKGROUND OF THE INVENTION

The invention relates to the field of prosthetic medical care with dental implants, and particularly to the practical arrangement of measurements, construction and production of suprastructures with the assistance of CAD/CAM systems.

Prosthetic medical care with dental implants is currently a task that is performed by the dentist together with his dental laboratory. The upper edge of an enossal dental implant lies typically near the top of the jawbone in a flush manner. The difference in height between the implant head and the occlusion plane of the teeth neighboring the implant can be to such a degree that the two structures can no longer be measured simultaneously with optical measuring systems based on the limited depth-of-focus, especially in the region of the incisors or the premolar region. The problem is additionally compounded in that toothless jawbones degenerate after a short time and these distances are further enlarged.

The upper edge of the implant lies additionally in a region which is regularly flushed by saliva and other body fluids and in which there are glands producing various secretions. It is difficult therefore to keep the implant head dry to such a degree that it can be measured directly in the patient's mouth.

The implant head is usually designed in a manner so that a mechanically highly sound connection is made having little tolerance with an excellent fit and having a good frictional connection relative to the suprastructure or to an abutment. This results in geometric designs of the implant head which are difficult to measure with the required accuracy by means of the traditional intraoral measuring method. This applies especially when the implant head is powdered. The problem is additionally compounded through an uneven powder application.

The implant is surrounded by the gingiva or the bone substance. Both surfaces can be powdered only with great difficulties to a degree so that they can be measured with the traditional intraoral measuring method.

A model has been necessary heretofore for the medical care with an implant disposed directly in the mouth of a patient. The position and orientation of the implant is applied to the working model of the dental technician by taking impressions in a costly method. All subsequent construction is then performed on that model.

The manufacturing of abutments or crowns for implants is currently a service that is exclusively performed by a dental laboratory. However, the dentist installs the implants. The dentist takes an impression of the developed situation after a period of healing. He transfers the position of the implants by means of insertion of the replicas into the impression. The dental technician subsequently transfers the position of these implants to his master model by means of an analog method. The dental technician uses then the selection of abutments offered by the respective manufacturer of the employed implant. The abutments are possibly still manually adjusted to the requirements of the situation before the dental technician fabricates a crown in a conventional manner. The abutment and crown are implanted in the patient in subsequent operational steps.

EP 1 062 916 A2 discloses a method for producing a tooth replacement as well as a method for producing a tooth replacement element based on the making of a negative impression of the jaw, which makes possible the placement and measuring of implants for the construction of frameworks with the aid of a working model manufactured thereof. The therein given definitions and descriptions of the basic procedure for the preparation of a measurement or for the subsequent construction and production are completely included in the present application.

The therein described method is based on the fact that a so-called manipulation implant is inserted into a conventional impression and a situation is established on the model thereby as it exists in the mouth of a patient after incorporation of the implant. This clinical situation is measured with the aid of a scanner with the goal to produce an abutment and a suprastructure. An auxiliary element is used for the position determination of the implant.

The work is computerized in this method which the dental technician has to-carry out already now according to the state-of-the-art which means, the intermediate steps to be accomplished are digitalized, such as modeling of the abutment, the framework and the facing, and they are subsequently ground to a finish. po EP 1 062 916 A2 discloses furthermore a working model with installed manipulation implants on which there is provided a positioning element having an auxiliary element suited for measurement. Implant data is acquired from the measuring data whereby said implant data is used for the construction of a suprastructure in the form of an abutment.

A disadvantage is thereby that a model has to be created at first to show the position and orientation of the axis of a dental implant in the clinical situation of the jaw and to subsequently make an implant structure. The proposed methods require a separation between the activity of the dentist on the patient himself and the activity of the dental technician on a model. Application of the method on the patient himself is not possible.

It is the object of the invention to provide a device and a method with which it will be possible to perform construction and manufacturing of the necessary suprastructures directly on the patient with a CAD/CAM apparatus, as desired, without the assistance of a dental laboratory or a dental technician—or to make the work processes of the dental technician more economical and efficient.

### SUMMARY OF THE INVENTION

According to the invention, the clinical situation in the mouth of a patient can be optically measured with a measuring camera whereby measurement data is provided. All required data about the position and orientation of the axis of the dental implant can be obtained from said measurement data. Subsequently, the creation on an implant suprastructure is made possible through CAD/CAM methods.

Measurement data is analyzed to determine the position and orientation of a shape or geometry to be measured during the method of detecting the position and orientation of the axis of a dental implant disposed directly in the patient's mouth whereby said measurement data is acquired through optical measurement of the clinical situation of the implant in the patient's mouth by means of a suitable method, i.e. image processing. A first shape to be measured is applied to the implant whereby said shape is formed in such a manner that a conclusion can be made about the position and orientation of the implant. The relative position and orientation of the axis of the dental implant and the optical axis of the measurement is determined by the position of the first shape to be measured, and the position and orientation of the implant itself is determined through said shape. The advantage is in the fact that the clinical situation is detected directly in the patient's mouth so that manufacturing of a model is no longer necessary.

The first shape to be measured is advantageously applied to the measurement unit, which has also a connection shape for the implant, and the relative position and orientation of the connection shape is determined from said first shape. The use of commercially available implants is made possible since they have standard connection shapes for the superstructure to be created. In addition, the first shape can be formed independently from the connection shape.

According to an advantageous development, the clinical situation of the implant and of the neighboring teeth is analyzed through the measurement data, and an axis relative to the axis of measurement is determined. This axis may be the insertion axis of the upper part of the implant suprastructure, i.e. a crown; however, it could also be an axis oriented along the occlusion plane, which is then perpendicular to the insertion axis. It is also possible to adjust this axis manually or to let the user select the axis by viewing the set of measurement data.

With the thereby determined or selected axis, it is possible to define the insertion direction of a crown relative to the axis of the implant. It is made possible thereby to determine the essential components of the abutment as part of the implant suprastructure, namely the type, position and orientation of the implant connection, height and shape of the abutment construction and the cervical border of the abutment.

The herein proposed method, which is the determination of position and orientation of the compensation angle of an implant suprastructure relative to a dental implant disposed directly in the patient's mouth, is developed so that the compensation angle is defined by the measured angle between the axis of the dental implant and the axis of measurement and the measured angle between the axis of measurement and the axis defined by the occlusion plane or the morphology of the tooth to be replaced.

The term “solid angle” is also used in place of the term of “compensation angle”.

According to an additional development, the implant suprastructure is made with a specific compensation angle, particularly with CAD/CAM methods.

The first shape to be measured is provided with a least one section designed in such manner so that the type of the existing implant can be obtained from the analysis of this section. In this case, measuring units having different measurement shapes are employed for the different implants.

The connecting shape of the implant is provided with at least one section designed in a manner so that the type of the existing implant can be determined through analysis of this section.

An additional object of the invention is a device, especially to carry out the aforementioned method, wherein measurement data is analyzed in an evaluation unit through a suitable method and the position and orientation of the first shape to be measured is determined thereby. The measurement data was acquired thereby through measurement of the clinical situation of an implant and of the neighboring teeth in the patient's mouth. The first shape to be measured was thereby applied to the implant to draw conclusions about the position and orientation of the connection shape of the implant. The relative position and orientation of the area between the axis of the dental implant and the axis of measurement is determined in the evaluation unit through the position of the first shape to be measured. In addition, the connection shape as well as the position and orientation of the implant itself is determined in the evaluation unit based on the first shape to be measured.

An implant with an integrated shape to be measured can be used and an additional measurement unit can be provided as well.

The clinical situation is advantageously analyzed in the evaluation unit or the neighboring teeth are analyzed using the measurement data and an axis relative to the axis of measurement is determined.

Furthermore, a compensation angle is determined in the evaluation unit whereby said compensation angle is defined by the measured angle between the axis of the dental implant and the axis of measurement and the measured angle between the axis of measurement and the axis of the occlusion plane. To this end, a processing unit is provided with which there can be constructed the implant suprastructure or, in case of multi-component structures, at least the connecting part on the implant with the specific compensation angle.

The first shape to be measured or the connection shape of the implant is advantageously provided with at least one section showing the type of the existing implant. This can be achieved by forming a specific geometric shape, an inscription or a colored marking.

An additional object of the invention is a mounting piece and a method for the use of this mounting piece.

According to the invention, a mounting piece on an implant inserted in a jawbone or a manipulation implant in a working model is provided with a positioning device and a fastening device for the implant as well as a section provided with a code. An extension is provided between the positioning device and said section whereby the length of the extension is coded in the section. It is made possible thereby to determine the position of the implant head through measurement of the mounting piece.

The extension is advantageously at a length whereby the section is brought to the level of the occlusion plane of the neighboring teeth.

According to a further development of the invention, the surfaces of the sections have a high backscatter coefficient with a Lambert scattering distribution in the invisible as well as in near infrared range of the spectrum. The surface may be coated thereby. An equalizing device movable relative to the extension is advantageously provided which circumferentially surrounds the mounting piece and which is provided with a contact surface to rest against the gingiva surrounding the tooth restoration. The place to be measured can thus be kept free from blood and saliva. In addition, the equalizing piece can be considered a substitute model for the shape of the gingiva.

The equalizing device is advantageously changeable and can be selected thereby to fit to the actual restoration site in term of size and shape.

The equalizing device may thereby be adjustable in its orientation and may be provided with an identification marking making determination of the orientation possible.

The inventive method for measurement of an implant inserted in a jawbone or of a manipulation implant provided in a working model includes furthermore the use of a mounting piece, which is attached to the implant or the manipulation implant, whereby the length of the extension is coded in a section and whereby a mounting piece is positioned and fastened on the implant and whereby a conclusion can be made about the position of the implant in the region of the jaw through a section of the mounting piece provided with codes. The length of the extension can be determined through evaluation of the coded section after measurement and establishment of a three-dimensional data set.

The method according to the invention will now explained with the aid of the attached drawings.

### BRIEF DESCRIPTION OF THE DRAWINGS

FIG. 1 shows a clinical situation of an implant with neighboring teeth disposed in a patient's mouth;

FIG. 2 shows a cross section through a measuring unit;

FIG. 3a shows a top view onto the connection shape of the implant;

FIG. 3b shows another implant together with connection shape and the first shape to be measured;

FIG. 4 shows a schematic drawing of an arrangement according to the invention;

FIG. 5 shows an implant suprastructure in the form of an abutment;

FIG. 6 shows a typical preparation site for a tooth restoration together with a mounting piece according to the invention in a cross-sectional view; and

FIG. 7 shows a mounting piece according to the invention in a side view.

### DETAILED DESCRIPTION

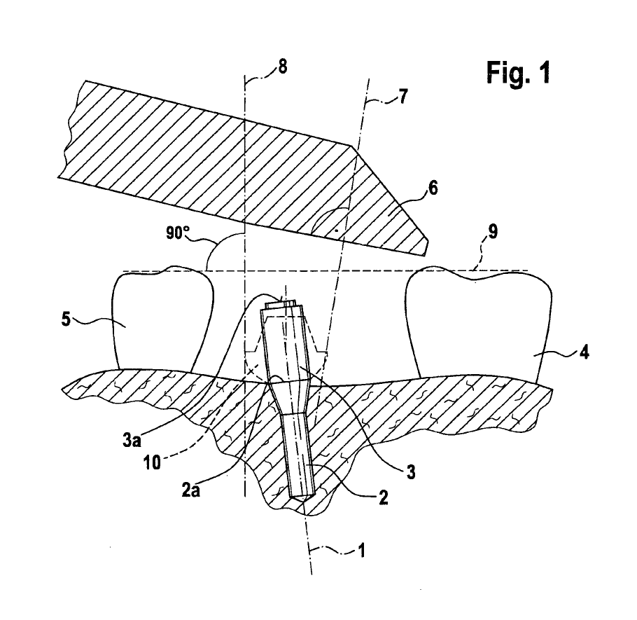

The method to detect the position and orientation of axis 1 of a dental implant 2 is explained with the aid of FIG. 1. At first, a measuring unit 3 with a first shape to be measured 3a is placed on the implant 2 disposed directly in the patient's mouth. The clinical situation, made up by the implant 2 and the existing neighboring teeth 4, 5, are optically measured, i.e. with a measuring camera 6. Three different axes determining the direction are relevant at this point: The axis 1 of the dental implant, an optical axis 7 of the measuring camera, and axis 8 of the tooth determined with consideration of neighboring teeth and which is used as the insertion axis, for example. Axis 8 lies perpendicular to an envisioned occlusion plane 9 in case where the neighboring teeth 4, 5 are molars.

Known characteristics of the tooth to be replaced can be obtained from a dental library, for example, to determine the tooth axis 8 as an addition to the system of the invention.

The relative position and orientation of the area between axis 1 of the dental implant 2 and the optical axis of the measuring camera 6 is determined in a first step. A measured image taken by the measuring camera 6 is analyzed through a suitable method of image processing and the position and orientation of the first shape to be measured 3a is determined. A conclusion can be made about the connection shape 2a based on the first shape 3a and also about the position and orientation of the implant 2 itself.

The clinical situation is analyzed by means of the image in a second step. The neighboring teeth 4, 5 are taken into consideration thereby. This analysis provides an axis 8 relative to the optical axis 7 of the measuring camera 6. One part of the implant suprastructure 10, namely the abutment 10, compensates later for the angle between axis 1 of the dental implant and axis 8 of the tooth. The implant suprastructure consists here of an abutment and a facing (not illustrated), which means, it consists of two parts. However, the implant suprastructure can also be in one piece.

The compensation angle is defined by the measured angle between the axis 1 of the dental implant and the optical axis 7 of the measuring camera and the measured angle between the optical axis 7 of the measuring camera 6 and the axis 8. The compensation angle is thus independent from the optical axis 7 of the measuring camera 6.

The design of the implant structure occurs then in the computer with the assistance of a CAD/CAM system, for example. There is no longer the necessity to create a costly working model with which tooth replacements have been produced in the past.

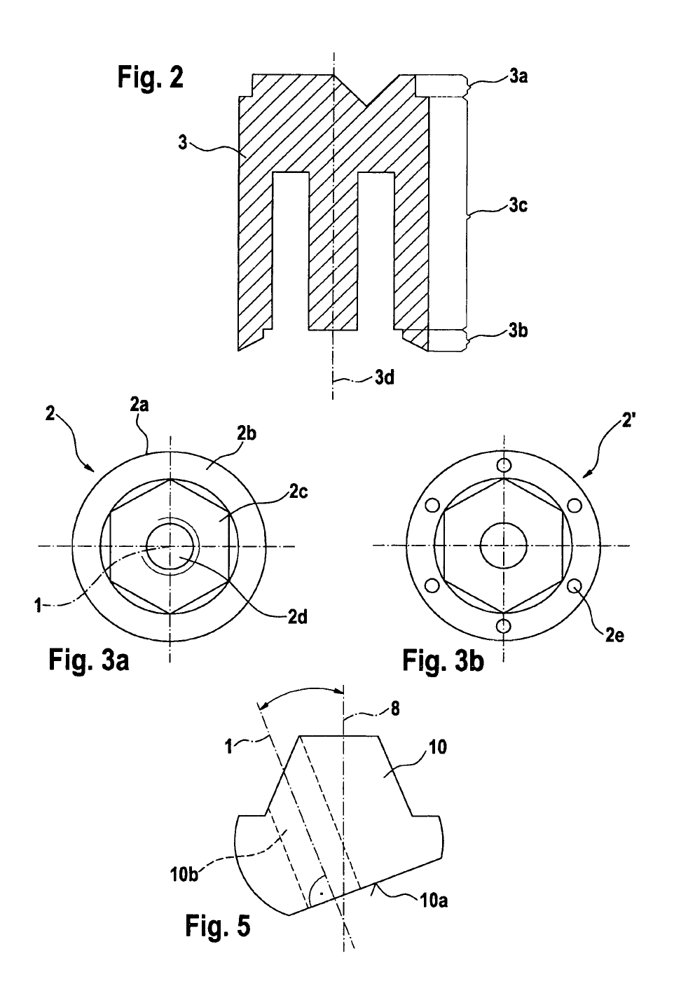

FIG. 2 illustrates the measuring unit 3 in an enlarged manner. The measurement unit 3 is provided with a precisely crafted first shape 3a at its upper end and a connection shape 3b at its lower end connecting to the implant (not shown in FIG. 2). An extension 3c is provided between the first shape 3a to be measured and the connection shape 3b so that said shape 3a is raised advantageously to the level of the occlusion plane 9 of FIG. 1. There exists a clearly geometric relationship between the connection shape and the first shape to be measured. The geometry of the implant itself does not have to be measured therefore directly since it is measured indirectly through the first shape.

The first shape to be measured is designed in such a manner that its position and orientation can be detected from an image obtained from the measurement data through suitable image processing.

Usually, dental implants do not show a clearly single symmetry but has a symmetry of multiple elements, i.e. six or eight in number. The measurement of the first shape allows a clear conclusion about the position and orientation of the connection shape corresponding to the symmetry.

Should differently formed first shapes be selected along with differently formed connection shapes, then said first shapes can be differentiated automatically. However, should the same first shapes be selected along with several different connection shapes, then a selection of the implant to be used has to be made by the practitioner in each case.

The connection shape 3b is formed in such a way that it can be placed onto the implant providing a positive fit.

FIG. 3a shows a top view onto the implant 2 so that the connection shape 2a of the measurement unit 3 can be seen (whereby the measurement unit 3 is not illustrated). It shows here a conical section 2b for centering the component to be connected and a section 2c with a partially symmetry in the form of a hexagon for spatial alignment of the components to be connected. Fastening is accomplished through internal threads 2d. Connection shapes of this type are the state-of-the-art. Various connection shapes are provided for differently shaped implants, e.g. from different manufacturers of being of different design.

If an implant 2′ has also a measurable shape 2e illustrated in FIG. 3b in addition to the connection shape for the suprastructure, then the implant can be measured directly with a suitable measuring instrument and the spatial direction can be determined without a measurement unit. Shape 2e to be measured has hemispherical recesses whereby the amount of recesses and their orientation lie in manner so that the spatial alignment of the implant can be determined.

In addition, an identification marking can be provided on the implant, which can be bar codes, color codes, written identification or any other type.

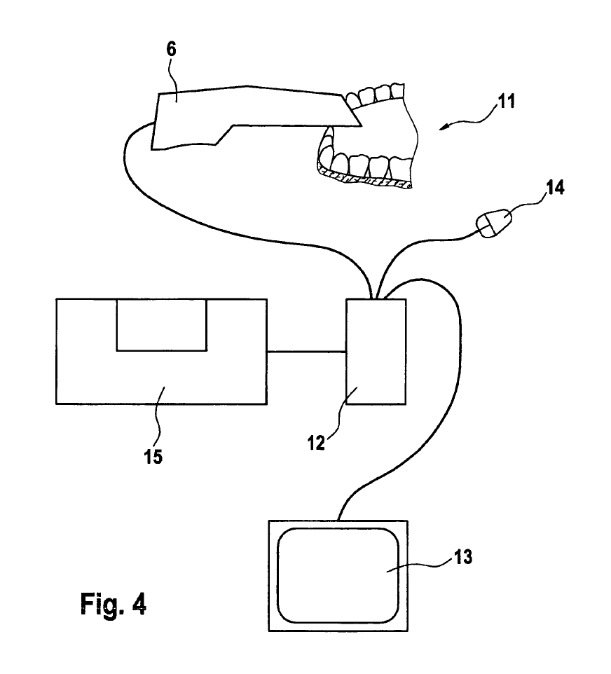

FIG. 4 illustrates a device with which the method according to the invention can be carried out. The device comprises a measuring camera 6 to measure the clinical situation in the patient's mouth. The measurement data acquired through measurement with the camera 6 are processed in the evaluation unit 12 and possibly stored therein. A display unit 15 is provided to make measured data viewable whereby the evaluation unit 12 can be controlled via input means 14. Moreover, a processing unit 13 is provided and it is connected to the evaluation unit 12 for the purpose of data exchange. Of course, data exchange between the evaluation unit 12 and the processing unit 13 can also be accomplished in another way. An implant suprastructure 10 can be produced in the processing unit 13 taking into consideration the angle of the implant, the insertion direction, or the desired occlusion.

FIG. 5 depicts an embodiment example of an implant suprastructure in the form of an abutment 10. The abutment 10 is shaped in a manner so that compensation takes place between the implant axis 1 and the direction of axis 8. A connection shape 10a is also provided to be applied to the connection of the implant whereby a screw-on connection with the implant is possible through a bore 10b.

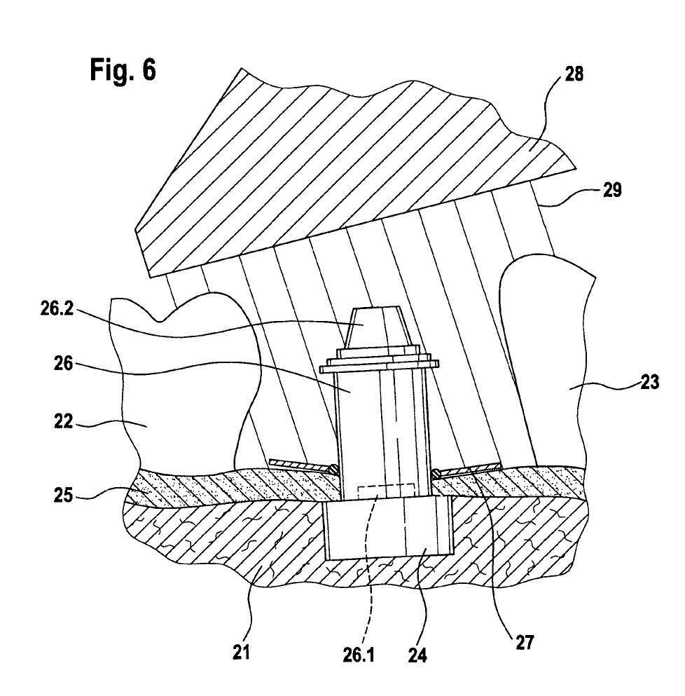

FIG. 6 illustrates a typical preparation site for a tooth restoration. An implant 24 is inserted between the teeth 22, 23 into a jawbone 21 having existing teeth 22, 23. The jawbone 21 is covered with gingiva 25, which is punctured in the area of the implant 24 by a mounting piece 26 connected along a fitting surface lying in between and being a component of a positioning device 26.1.

The fitting surface of the implant is usually designed in a manner so that a good positive fit and a relatively good resistance against twisting is provided whereby the necessary sanitary requirements are considered as well. Various fitting surfaces have been developed historically. The counter-pieces to these surfaces are reproduced and are components of the mounting piece 26.

The mounting piece 26 serves as a slide for an equalizing device 27 surrounding said mounting piece whereby said equalizing device 27 determines and maintains the gingiva level. It is transversely movable along the mounting piece 26 and it can be exchanged after separation from the implant 24. The equalizing piece can be described as a gingiva plate and it is flexibly adjustable in its orientation.

The movable equalizing device 27 is disposed within the depth-of-focus range of an intraoral measuring camera 28 of which only the most forward area is illustrated showing a measuring beam 29 radiating from a measuring aperture. The position and orientation of the equalizing device 27 is obtained from the measured data.

A section 26.2 is provided on the mounting piece 26, which is known to the CAM system in its structure and/or coding and which allows a conclusion about the position and orientation of the implant. With CAM is meant the computer assisted production based on three-dimensional data sets.

The necessary measurement data can be acquired also in a moist and bleeding operation site because of the use of the equalizing device 27, the so-called gingiva plate.

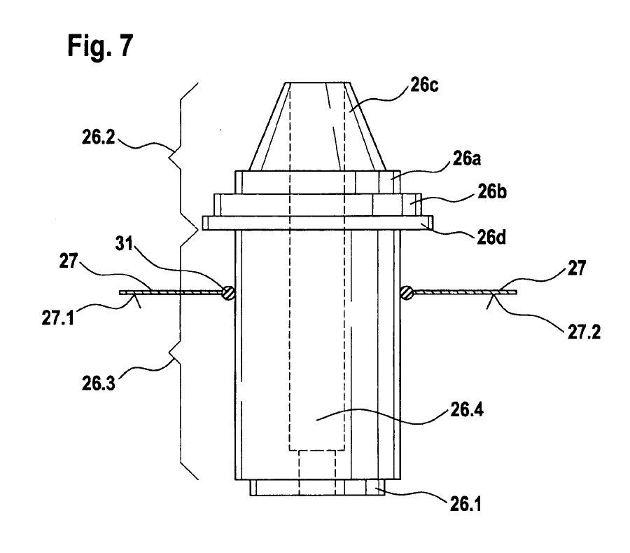

FIG. 7 shows a mounting piece 26 in a side view whereby the equalizing device 27 is shown as well. Various functional areas can be detected on the mounting piece 26.

The positioning device 26.1 is disposed at the lower end for accurate positioning of an implant (not shown). The fitting surface of the implant is designed uniformly in a manner so that a good positive fit is achieved as well as a relatively good resistance against twisting and whereby the necessary sanitary requirements are considered as well. Various fitting surfaces have been developed historically. The counter-pieces to these surfaces are reproduced in the mounting piece. At this lower end, fastening is accomplished through an indicated interior threaded connection 26.4.

At the upper end is the section 26.2 containing coded information. The pieces of information are coded by means of different surface areas. The characteristics contain pieces of information about the geometric orientation of the fitting surface of the implant and about the characteristics of the inserted implant (manufacturer, size, type etc.)

One surface 26a, which lies concentric to the rotational axis of the implant, determines the rotational axis of the implant head.

Surface 26b is fitted in its radius or its direction to the existing implant and serves therefore to detect the type of implant.

Surface 26c serves for an automatic search of the mounting piece 26 in the three-dimensional data set acquired through measurements.

The length of the below-described extension 26.3 is coded on an additional surface 26d. It is easily possible thereby to determine the top of the implant head—even if the implant head itself lies outside the measuring range of the camera.

The surfaces 26a-d are considered separate geometric areas on the mounting piece 26. The basic principle exists in the fact that these are surface elements known to the CAD/CAM system for their structure and/or coding and they are considered during the construction of dental fitting bodies or suprastructures by means of computers.

An extension 26.3 is disposed between the two ends of the mounting piece 26 whereby said extension 26.3 has the purpose to bring the measurable parts 26a-d up to the level of the occlusion plane of the neighboring teeth. Said mounting piece 26 serves at the same time as a slide for an equalizing device 27, also identified as gingiva plate.

This gingiva plate 27 determines and maintains the gingiva level. The sides 27.1 and 27.2 serve as contact surfaces of the equalizing device 27 onto the healthy gingiva, as it can be seen in FIG. 6. The equalizing device 27 can be designed disk-like, for example, and the fitting to the shape of the preparation site is achieved only by deforming the plate on location. A saddle-shaped equalizing device can also be used partly covering the jaw cross-section in a lateral manner.

The equalizing device 27 is transversely movable along the extension 26.3. It can be exchanged and it is flexibly adjustable in its orientation. Should the teeth neighboring the supplied implant be at a distance apart, then the equalizing device 27 could also be curved in longitudinal direction with consideration to the anatomical condition of the curvature of the jaw. Based on the enlarged illustration, it can be seen that a seal 31 is arranged surrounding the mounting piece 26 preventing blood and saliva from entering section 26.2.

At least the section 26.2 is preferably coated with a material having a high backscatter coefficient with a Lambert scattering distribution in the visible and in the near infrared range of the spectrum. The equalizing device 27 can also have a surface of this type.

In conjunction with the CAD/CAM supported production of suprastructures, the mounting piece 26 with its equalizing device 27 is at first fastened to the implant 24 and the equalizing device 27 is subsequently moved up to the level of the gingiva 25. Measurements and the creation of a three-dimensional data set are performed subsequently.

The mounting piece comprises a section 26.2 of known geometry. This geometry makes possible, because of its regularity, the automated detection of such structures in the three-dimensional data sets. This geometry makes further possible the determination of the orientation of the implant and the position of nonisotropic parts of the implant.

This geometry makes also possible the detection of characteristics such as the manufacturer, type and size of the employed implant, for example. Based on the selected length of the extension 6e, the section lies thereby within the depth-of-focus range of the measuring camera and in fact at the level of the occlusion plane.

Found can be automatically the image contained in the measured three-dimensional data set—or the image acquired from it—or the visible mounting piece 26 through correlation of the three-dimensional data set with a template, which mirrors the part 6c of the mounting piece or the entire arrangement. The user can alternatively assist with special inputs, for example.

The determination of the relative position of the implant head and of the occlusion plane of the teeth neighboring the implant is subsequently performed. The height or level of the gingiva is determined by means of the disk-like part, for example.

The lower guide line of an aligned tooth is placed in mesiodistal direction slightly under the gingiva level as established by the equalizing device 27.

This can be performed directly after insertion of the implant in the preparation site or after successful healing as well.

1. A method to determine position and orientation of the axis of a dental implant disposed directly in the mouth of a patient, wherein measurement data is acquired through measurement of the clinical situation of the implant in the patient's mouth, whereby a first shape to be measured is applied to the implant, whereby said first shape is formed in such a manner that a conclusion can be made about the position and orientation of a connection shape of the implant, whereby the position and orientation of said first shape is analyzed through a suitable method;
the relative position and orientation of the area between the axis of the dental implant and the axis of the measurement is defined through the specific position of said first shape;
and whereby the position and orientation of the implant itself is determined through said first shape.

2. A method according to claim 1, wherein said first shape to be measured is applied to the measurement unit, which also has a connection shape for the implant, and whereby the relative position and orientation of the connection shape is determined from said first shape.

3. A method according to claim 1, wherein the clinical situation of the implant and of the neighboring teeth is analyzed through the measurement data and whereby an axis relative to the axis of measurement is determined.

4. A method according to claim 3 to determine the position and orientation of the compensation angle of an implant suprastructure for connection to an implant disposed directly in the patient's mouth, wherein a compensation angle is determined which is defined by the measured angle between the axis of the dental implant and the axis of the measurement and the measured angle between said axis of the measurement and axis.

5. A method according to claim 4, wherein the implant suprastructure is fabricated having a specific compensation angle.

6. A method according to claim 5, wherein said first shape is provided with at least one section designed in a manner so that the type of the existing implant can determined through analysis of said section.

7. A method according to claim 6, wherein the connection shape of the implant has at least one section designed in a manner so that the type of the existing implant can be determined through analysis of said section.

8. A device, particularly to carry out the method according to claim 1, wherein
measurement data is analyzed in an evaluation unit whereby said measurement data is acquired through optical measurement of the clinical situation of an implant and of the neighboring teeth in the patient's mouth, whereby a first shape is applied to the implant and whereby said first shape designed in a manner to be able to draw a conclusion about the position and orientation of a connection shape of the implant, and whereby measurement data is analyzed through suitable methods and the position and the orientation of said shape is determined thereby;
whereby the relative position and orientation of the area between the axis of the dental implant and the axis of measurement is determined in the evaluation unit through the specific position of the first shape to be measured;
whereby the position and orientation of the implant itself is determined in the evaluation unit based on said first shape to be measured.

9. A device according to claim 8, wherein
the clinical situation or the neighboring teeth are analyzed in the evaluation unit using the measurement data and an axis relative to the axis of measurement is determined;
a compensation angle is determined in the evaluation unit whereby said compensation angle is defined by the measured angle between the axis of the dental implant and the axis of measurement and the measured angle between the axis of measurement and the axis;
a processing unit is provided with which the implant suprastructure can be constructed having the specific compensation angle.

10. A device according to claim 8, wherein said first shape has at least one section designed in a manner so that the existing implant can be determined through analysis of this section.

11. A device according to claim 10, wherein the connection shape of the implant has at least one section designed in a manner so that the existing implant can be determined through analysis of this section.

12. A mounting piece on an implant inserted in a jawbone or a manipulation implant in a working model is provided with a positioning device and a fastening device for the implant as well as a section provided with a code, wherein an extension is provided in said section whereby the length of the extension is coded in the section and whereby the extension has such a length that said section is brought to the level of the occlusion plane of the neighboring teeth.

13. A mounting piece according to claim 12, wherein the surfaces of said sections have a high backscatter coefficient with a Lambert scattering distribution in the invisible as well as in near infrared range of the spectrum.

14. A mounting piece according to claim 13, wherein the surface is coated.

15. A mounting piece according to claim 12, wherein
an equalizing device movable relative to the extension is provided, whereby said equalizing device circumferentially surrounds the mounting piece and whereby contact surfaces are provided which rest against the gingiva surrounding the tooth restoration.

16. A mounting piece according to claim 14, wherein said equalizing device is changeable.

17. A mounting piece according to claim 16, wherein said equalizing device is adjustable in its orientation and is provided with identification marking making determination of the orientation possible.

18. A method for measurement of an implant inserted in a jawbone or of a manipulation implant provided in a working model whereby a mounting piece is positioned and attached on the implant, whereby a conclusion can be made about the position of the implant in the region of the jaw through a section of the mounting piece provided with codes, wherein a mounting piece is fastened to the implant or the manipulation implant, whereby said mounting piece has an extension between the positioning device and said section, whereby the length of the extension is coded in said section, and whereby the length of the extension can be specified through evaluation of the coded section after measurement and after establishing a three-dimensional data set.

19. A method according to claim 18, wherein the length of the extension of the mounting piece is selected in a manner so that the coded sections are raised approximately to the level of the occlusion plane of the neighboring teeth.

20. A method according to claim 18, wherein a equalizing device, which is movable relative to the extension, is positioned before measurement on the gingival surrounding the tooth restoration and later included in the measurement.
